(19) United States
(12) Patent Application Publication
(10) Pub. No.: US 2018/0075726 A1
(43) Pub. Date: Mar. 15, 2018

(54) TAP WATER USE DETECTION SYSTEM, WATCHING SYSTEM USING SAME, TAP WATER USE DETECTION METHOD, WATCHING METHOD, AND COMPUTER-READABLE RECORDING MEDIUM

(71) Applicant: NEC SOLUTION INNOVATORS, LTD., Tokyo (JP)

(72) Inventor: Yoshinobu INAGAKI, Tokyo (JP)

(73) Assignee: NEC SOLUTION INNOVATORS, LTD., Tokyo (JP)

(21) Appl. No.: 15/562,100

(22) PCT Filed: Mar. 30, 2016
(86) PCT No.: PCT/JP2016/060364

§ 371 Date: Sep. 27, 2017

(30) Foreign Application Priority Data
Mar. 31, 2015 (JP) 2015-071275

(51) Int. Cl. G08B 21/04

(52) U.S. Cl. CPC G08B 21/0484; G08B 21/0415; G08B 21/0461

(57) ABSTRACT

A system that enables high-precision detection of a purpose of using tap water is realized with simple and low-cost configurations so as to enable high-precision detection of an abnormality exhibited by a watched person in accordance with a use status of tap water. A tap water use detection system (1) includes: a used tap water amount acquisition unit (11) that acquires information related to an amount of used tap water from a tap water meter (2) for measuring an amount of used tap water; a tap water use calculation unit (12) that calculates an amount of used tap water and the duration of use of tap water based on the information related to the amount of used tap water acquired by the used tap water amount acquisition unit (11); and a tap water purpose determination unit (13) that determines a purpose of using tap water based on the amount of used tap water and the duration of use of tap water calculated by the tap water use calculation unit (12).

### TECHNICAL FIELD

The present invention relates to a tap water use detection system for detecting a purpose of using tap water in accordance with a use status of tap water, a watching system that uses the tap water use detection system, a tap water use detection method, a watching method, and a computer-readable recording medium having recorded therein a program for realizing these systems and methods.

### BACKGROUND ART

Due to the progressively aging society of recent years, an increasing number of elderly people are living alone without being directly watched over by nearby family members. For this reason, there has lately been increasing demand for a watching service that watches over an elderly person living alone for 24 hours so that, if the elderly person exhibits an abnormality, the abnormality can be quickly detected.

Conventionally, methods of detecting an abnormality exhibited by a watched person, such as an elderly person, in various ways have been studied as watching services. Examples include a method in which a watching person is alerted when the watched person presses an emergency alert button by themselves on the occurrence of an abnormality, and a method using surveillance cameras.

However, the method in which the watched person presses the alert button by themselves on the occurrence of an abnormality imposes a large physical burden on the watched person. On the other hand, the method using the surveillance cameras requires installation of the surveillance cameras in the space of privacy, and thus imposes a large psychological burden on the watched person.

Other methods that have been studied include a method using sensors and the like. For example, Patent Document 1 discloses a watching system that generates contents indicating living conditions of a watched person by applying data processing to living information data that has been obtained from raw data collected using a plurality of monitors installed in a residence of the watched person. The watching system then transmits the contents to a terminal of a watching person. Note that according to the configurations of Patent Document 1, one of the monitors that detect the living conditions of the watched person is a tap water sensor that checks the time of use of tap water and an amount of used tap water.

In recent years, in order to reduce psychological and physical burdens on a watched person, a method of detecting an abnormality exhibited by the watched person by checking a flow rate of tap water has been studied on many occasions. For example, Patent Document 2 discloses a toilet use detection system and a safety confirmation system using the same. This toilet use detection system obtains a flow rate pattern based on flow rate data that is obtained from a flow rate of water flowing in a water supply pipe, and detects whether a flush toilet has been used by comparing the obtained flow rate pattern with a flow rate pattern associated with use of the toilet.

On the other hand, Patent Document 3 discloses a living environment assistance system that calculates a time period in which a given amount of water was continuously used based on the result of measurement performed by a water amount meter, and issues a warning if the calculated time period exceeds a preset time period. With this system, a warning indicating an abnormality can be issued on the occurrence of an event that contradicts a normal living pattern of a dweller.

Furthermore, Patent Document 4 discloses a watching service apparatus that measures an amount of water demand. This apparatus analyzes a purpose of using tap water based on an amount of used tap water and the time of use of tap water, and ascertains a change in a health condition from the frequency of use of tap water for that purpose.

### LIST OF PRIOR ART DOCUMENTS

### Patent Documents

Patent Document 1: JP 2005-346292A

Patent Document 2: JP 2013-25472A

Patent Document 3: JP 2000-285346A

Patent Document 4: JP 2014-232461A

### DISCLOSURE OF THE INVENTION

### Problems to be Solved by the Invention

The foregoing systems that ascertain a condition of a watched person based on a use status of tap water can reduce psychological and physical burdens on the watched person. However, it is difficult to ascertain a condition of the watched person with high precision simply by checking the time of use of tap water and an amount of used tap water as with the configurations disclosed in Patent Documents 1 and 4, because the times of day at which a person uses a toilet and bathes differ among individuals and change on a daily basis.

Furthermore, when a purpose of using tap water is determined based on an obtained flow rate pattern as with the configurations disclosed in Patent Document 2, it is necessary to analyze characteristic amounts of temporal changes in an amount of used tap water that has been quantized at short sampling intervals with high precision. This makes it necessary to install dedicated flow rate sensors that obtain high-resolution data at short sampling intervals, thereby rendering the installation cost high.

Furthermore, when continuous use of tap water is detected as with the configurations disclosed in Patent Document 3, although it is possible to detect such an abnormality as a collapse of a watched person with water running, it is difficult to detect a small abnormality, for example, a change in a physical condition.

An object of the present invention is to realize a system that enables high-precision detection of a purpose of using tap water with simple and low-cost configurations so as to enable high-precision detection of an abnormality exhibited by a watched person in accordance with a use status of tap water.

### Means for Solving the Problems

In order to achieve the foregoing object, a tap water use detection system according to one aspect of the present invention detects a purpose of using tap water based on a use status of tap water. This tap water use detection system includes: a used tap water amount acquisition unit that acquires information related to an amount of used tap water from a used tap water amount measurement unit for measuring an amount of used tap water; a tap water use calculation unit that calculates an amount of used tap water and the duration of use of tap water based on the information related to the amount of used tap water acquired by the used tap water amount acquisition unit; and a tap water purpose determination unit that determines a purpose of using tap water based on the amount of used tap water and the duration of use of tap water calculated by the tap water use calculation unit.

In order to achieve the foregoing object, a watching system according to another aspect of the present invention detects an abnormality exhibited by a watched person. This watching system includes the foregoing tap water use detection system, and an abnormality notification unit that notifies a watching person of an abnormality when the number of times tap water has been used within a given term for the purpose of using tap water determined by the tap water purpose determination unit is different from a reference number.

In order to achieve the foregoing object, a tap water use detection method according to still another aspect of the present invention detects a purpose of using tap water based on a use status of tap water. This tap water use detection method includes: a used tap water amount acquisition step of acquiring information related to an amount of used tap water from a used tap water amount measurement unit for measuring an amount of used tap water; a tap water use calculation step of calculating an amount of used tap water and the duration of use of tap water based on the information related to the amount of used tap water acquired in the used tap water amount acquisition step; and a tap water purpose determination step of determining a purpose of using tap water based on the amount of used tap water and the duration of use of tap water calculated in the tap water use calculation step.

In order to achieve the foregoing object, a watching method according to still another aspect of the present invention detects an abnormality exhibited by a watched person. This watching method includes: a used tap water amount acquisition step of acquiring information related to an amount of used tap water from a used tap water amount measurement unit for measuring an amount of used tap water; a tap water use calculation step of calculating an amount of used tap water and the duration of use of tap water based on the information related to the amount of used tap water acquired in the used tap water amount acquisition step; a tap water purpose determination step of determining a purpose of using tap water based on the amount of used tap water and the duration of use of tap water calculated in the tap water use calculation step; and an abnormality notification step of notifying a watching person of an abnormality when the number of times tap water has been used within a given term for the purpose of using tap water determined in the tap water purpose determination step is different from a reference number.

In order to achieve the foregoing object, a computer-readable recording medium according to still another aspect of the present invention has recorded therein a program including an instruction for causing a computer to execute: a used tap water amount acquisition step of acquiring information related to an amount of used tap water from a used tap water amount measurement unit for measuring an amount of used tap water; a tap water use calculation step of calculating an amount of used tap water and the duration of use of tap water based on the information related to the amount of used tap water acquired in the used tap water amount acquisition step; and a tap water purpose determination step of determining a purpose of using tap water based on the amount of used tap water and the duration of use of tap water calculated in the tap water use calculation step.

### Advantageous Effects of the Invention

As described above, the configurations of the present invention can realize a system that enables high-precision detection of a purpose of using tap water with simple and low-cost configurations so as to enable high-precision detection of an abnormality exhibited by a watched person in accordance with a use status of tap water.

### BRIEF DESCRIPTION OF THE DRAWINGS

FIG. 1 is a block diagram showing general configurations of a tap water use detection system.

FIG. 2 shows examples of criteria that are used by a tap water purpose determination unit according to a first embodiment in determining a purpose of using tap water.

FIG. 3 is a block diagram showing specific configurations of the tap water use detection system according to the first embodiment.

FIG. 4 shows examples of amounts of used tap water stored in a used tap water amount storage unit.

FIG. 5 shows examples of reference numbers set by a reference number setting unit.

FIG. 6 shows a flow of the operations of the tap water use detection system according to the first embodiment.

FIG. 7 shows exemplary configurations of a computer.

FIG. 8 is a block diagram showing specific configurations of a tap water use detection system according to a second embodiment.

FIG. 9 shows examples of criteria that are used by a tap water purpose determination unit according to the second embodiment in determining a purpose of using tap water.

FIG. 10 schematically shows a general relationship between an amount of used tap water and use of a sewage drain for each purpose of using tap water.

FIG. 11 shows a flow of the operations of the tap water use detection system according to the second embodiment.

### MODE FOR CARRYING OUT THE INVENTION

### First Embodiment

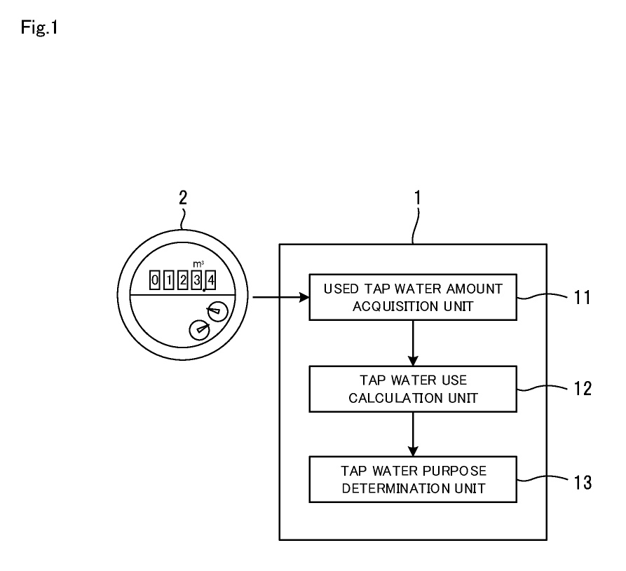

The following describes a tap water use detection system, a watching system, a tap water use detection method, a watching method, and a program according to a first embodiment of the present invention with reference to FIGS. 1 to 7.

FIG. 1 shows overall configurations of a tap water use detection system 1 according to the first embodiment of the present invention. The tap water use detection system 1 is constituted by, for example, a computer and the like disposed inside a meter box that houses a tap water meter 2 (a used tap water amount measuring unit). The tap water use detection system 1 reads in a flow rate of tap water measured by the tap water meter 2, and measures a time period in which water flows at that flow rate. The tap water use detection system 1 then determines a purpose of using tap water based on the flow rate that has been read in and the time period that has been measured.

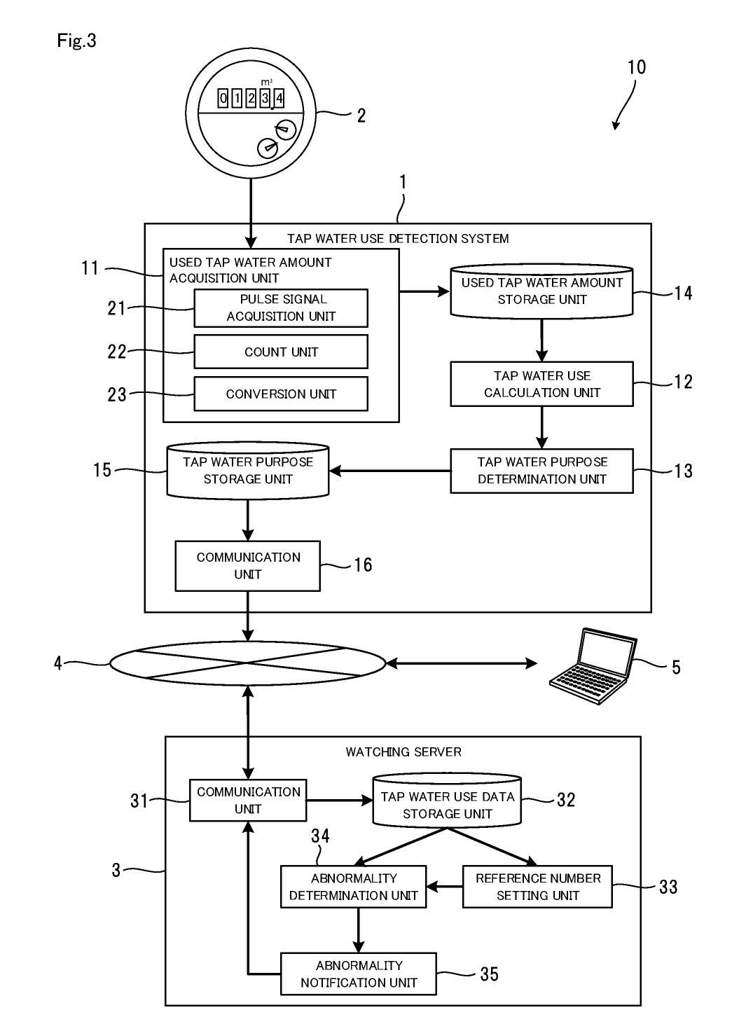

After determining the purpose of using tap water, the tap water use detection system 1 outputs the result of the determination to a watching server 3 (see FIG. 3) as will be described later in detail. This watching server 3 notifies a watching person of an abnormality when a predetermined condition has been satisfied, for example, when the number of times tap water was used for the purpose of using tap water determined by the tap water use detection system 1 is different from a reference number. That is to say, the tap water use detection system 1 constitutes a part of a watching system 10 that includes the watching server 3.

Although the tap water use detection system 1 according to the present embodiment constitutes a part of the watching system 10, no limitation is intended in this regard. The tap water use detection system 1 may be used in other systems that perform control in accordance with the purpose of using tap water and the frequency of determination of the purpose.

As shown in FIG. 1, the tap water use detection system 1 includes a used tap water amount acquisition unit 11, a tap water use calculation unit 12, and a tap water purpose determination unit 13. The used tap water amount acquisition unit 11 imports, into the tap water use detection system 1, flow rates of tap water measured by the tap water meter 2 that is installed in the tap water supply plumbing for a residence and the like. Specifically, the used tap water amount acquisition unit 11 reads in pulse signals (information related to an amount of used tap water) output from the tap water meter 2, and converts the pulse signals into an amount of tap water used per given time period. Regarding the pulse signals, the tap water meter 2 outputs one pulse each time a predetermined amount of tap water passes through the tap water meter 2. Therefore, the used tap water amount acquisition unit 11 acquires an amount of used tap water based on the number of pulses output in the given time period.

Based on the amounts of used tap water that were output from the used tap water amount acquisition unit 11 at intervals of the given time period, the tap water use calculation unit 12 calculates an amount of used tap water and the duration of use of tap water during continuous use of tap water. If an amount of used tap water output from the used tap water amount acquisition unit 11 is equal to or larger than a predetermined value, the tap water use calculation unit 12 determines that tap water has been in continuous use, and sums the amounts of used tap water and the durations of use of tap water until the output amount of used tap water becomes smaller than the predetermined value.

In this way, when a watched person uses tap water, an amount of used tap water and the duration of use of tap water can easily be calculated for each purpose of using tap water, such as bathing, laundry, and using a toilet.

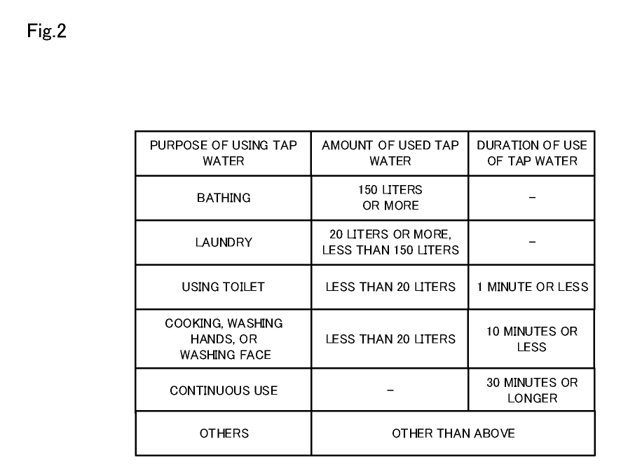

The tap water purpose determination unit 13 determines a purpose of using tap water based on the amount of used tap water and the duration of use of tap water calculated by the tap water use calculation unit 12. The tap water purpose determination unit 13 has, for example, a table related to an amount of used tap water and the duration of use of tap water for each purpose as shown in FIG. 2. Note that the numeric values contained in this table are examples, and this table may contain other numeric values. The numeric values contained in this table may be changed as appropriate. Furthermore, items that are contained in the table shown in FIG. 2 to indicate the purposes of using tap water are examples, and this table may contain other items. The items contained in this table may be changed as appropriate.

For each purpose, the tap water purpose determination unit 13 determines that tap water has been used for that purpose if the amount of used tap water and the duration of use of tap water calculated by the tap water use calculation unit 12 respectively satisfy the amount of used tap water and the duration of use of tap water corresponding to that purpose shown in FIG. 2.

For example, the tap water purpose determination unit 13 determines that the purpose of using tap water is using a toilet if the amount of used tap water is smaller than 20 liters and the duration of use of tap water is equal to or shorter than 1 minute.

Note that the tap water purpose determination unit 13 determines that tap water has been in continuous use if tap water has been continuously used for 30 minutes or longer. In this case, the watching server determines that the watched person is in an abnormal condition, for example, the watched person has collapsed with tap water running, and notifies the watching person of an abnormality.

The tap water use detection system 1 according to the present embodiment determines a purpose of using tap water based on an amount of used tap water and the duration of use of tap water calculated from a value measured by the tap water meter 2. Accordingly, the purpose of using tap water can be determined with high precision. Furthermore, as the purpose of using tap water can be determined using the existing tap water meter, the tap water use detection system can be realized with simple and low-cost configurations.

Moreover, determining the purpose of using tap water based on an amount of used tap water and the duration of use of tap water in the foregoing manner is less likely to be affected by individual differences than determining the purpose of using tap water based on an amount of used tap water and the times of day at which tap water is used. Therefore, the purpose can be determined with a certain level of precision without changing criteria for determining the purpose of using tap water depending on the watched person.

More specific configurations of the tap water use detection system 1 will now be described in detail using FIG. 3. FIG. 3 is a block diagram showing overall configurations of the watching system 10 including the tap water use detection system 1 according to the embodiment of the present invention. The watching system 10 includes the tap water use detection system 1 and the later-described watching server 3.

The tap water use detection system 1 includes the used tap water amount acquisition unit 11, the tap water use calculation unit 12, the tap water purpose determination unit 13, a used tap water amount storage unit 14, a tap water purpose storage unit 15, and a communication unit 16.

Every given time period, the used tap water amount acquisition unit 11 acquires pulse signals output from the tap water meter 2, converts the pulse signals into an amount of used tap water, and outputs the amount of used tap water to the tap water use calculation unit 12. Specifically, the used tap water amount acquisition unit 11 includes a pulse signal acquisition unit 21, a count unit 22, and a conversion unit 23. The pulse signal acquisition unit 21 acquires pulse signals output from the tap water meter 2. The count unit 22 is configured to count the given time period. Each time the count unit 22 counts the given time period, the conversion unit 23 converts the pulse signals that were acquired by the pulse signal acquisition unit 21 within the given time period into an amount of used tap water.

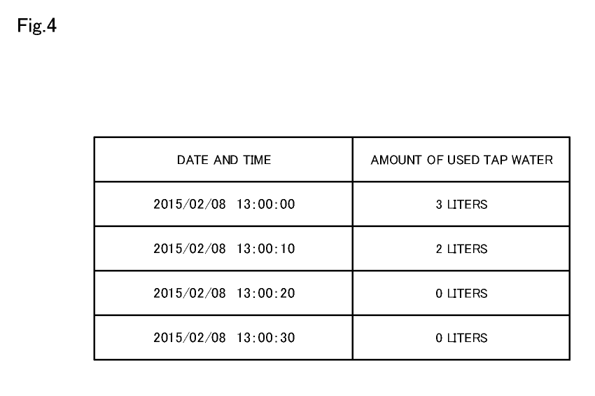

The used tap water amount storage unit 14 is constituted by, for example, a storage device, such as a flash memory. The used tap water amount storage unit 14 stores the amounts of used tap water that were output from the used tap water amount acquisition unit 11 at intervals of the given time period. That is to say, the used tap water amount storage unit 14 stores the amounts of used tap water that were output at intervals of the given time period in chronological order as shown in FIG. 4.

Based on the amounts of used tap water that were stored to the used tap water amount storage unit 14 at intervals of the given time period, the tap water use calculation unit 12 calculates an amount of used tap water and the duration of use of tap water during continuous use of tap water. That is to say, the tap water use calculation unit 12 determines that, among the amounts of used tap water that were stored to the used tap water amount storage unit 14 at intervals of the given time period, the amounts of used tap water that are equal to or larger than a predetermined value are indicative of continuous use of tap water for the same purpose. The tap water use calculation unit 12 sums these amounts of used tap water that are indicative of continuous use of tap water, as well as the corresponding durations of use of tap water, to calculate an amount of used tap water and the duration of use of tap water for that purpose.

A value that makes it possible to determine that tap water has been in continuous use is set as the predetermined value. The predetermined value is decided on in accordance with, for example, the detection performance of the tap water meter 2. That is to say, when the tap water meter 2 outputs a pulse signal per liter, one liter is set as the predetermined value.

The tap water purpose determination unit 13 determines a purpose of using tap water based on the amount of used tap water and the duration of use of tap water calculated by the tap water use calculation unit 12. That is to say, the tap water purpose determination unit 13 has the table shown in FIG. 2, and determines the purpose of using tap water based on this table and on the amount of used tap water and the duration of use of tap water calculated by the tap water use calculation unit 12. For example, when the amount of used tap water and the duration of use of tap water calculated by the tap water use calculation unit 12 are 15 liters and 5 minutes, respectively, the tap water purpose determination unit 13 determines that the purpose of using tap water is cooking, washing hands, or washing a face.

The tap water purpose storage unit 15 is constituted by, for example, a storage device, such as a flash memory. The tap water purpose storage unit 15 stores the purpose of using tap water that was determined by the tap water purpose determination unit 13. The tap water purpose storage unit 15 stores the purpose of using tap water in association with the corresponding time of day.

The communication unit 16 transmits the purpose of using tap water stored in the tap water purpose storage unit 15 as tap water use data to the watching server 3 via a network 4. That is to say, the communication unit 16 is connected to the network 4, which is the Internet or a dedicated network line for example, via wireless communication, such as low-power wireless communication, or wired communication.

Using FIG. 3, a description is now given of the configurations of the watching server 3 to which the tap water use data is transmitted from the tap water use detection system 1.

When the tap water use detection system 1 has transmitted the tap water use data, the watching server 3 receives the tap water use data via the network 4. For each purpose of using tap water contained in the received tap water use data, the watching server 3 determines that an abnormality has occurred if the number of times tap water was used for that purpose is different from a reference number that serves as a criterion for determining the occurrence of an abnormality. If the watching server 3 determines that a use status of tap water is abnormal, it notifies the watching person of an abnormality via the network 4.

Specifically, the watching server 3 includes a communication unit 31, a tap water use data storage unit 32, a reference number setting unit 33, an abnormality determination unit 34, and an abnormality notification unit 35. The communication unit 31 is connected to the network 4 in such a manner that the communication unit 31 can perform communication via the network 4. The communication unit 31 receives the tap water use data from the tap water use detection system 1 via the network 4, and transmits an abnormality notification signal to a display terminal 5 of the watching person via the network 4 when the abnormality notification unit 35 has generated the abnormality notification signal.

The tap water use data storage unit 32 is constituted by, for example, a storage device, such as a hard disk device and a flash memory. The tap water use data storage unit 32 stores the tap water use data received by the communication unit 31. This tap water use data contains a purpose of using tap water, the number of times tap water was used, an amount of used tap water, the duration of use of tap water, and so forth.

The reference number setting unit 33 sets reference numbers that each serve as a criterion used by the abnormality determination unit 34 in determining the occurrence of an abnormality. Specifically, for each purpose of using tap water, the reference number setting unit 33 obtains the average number of times tap water was used for that purpose in the latest predetermined term from the tap water use data stored in the tap water use data storage unit 32. The reference number setting unit 33 also obtains a standard deviation corresponding to the average number using the number of times tap water was used, and calculates the reference number in consideration of the standard deviation.

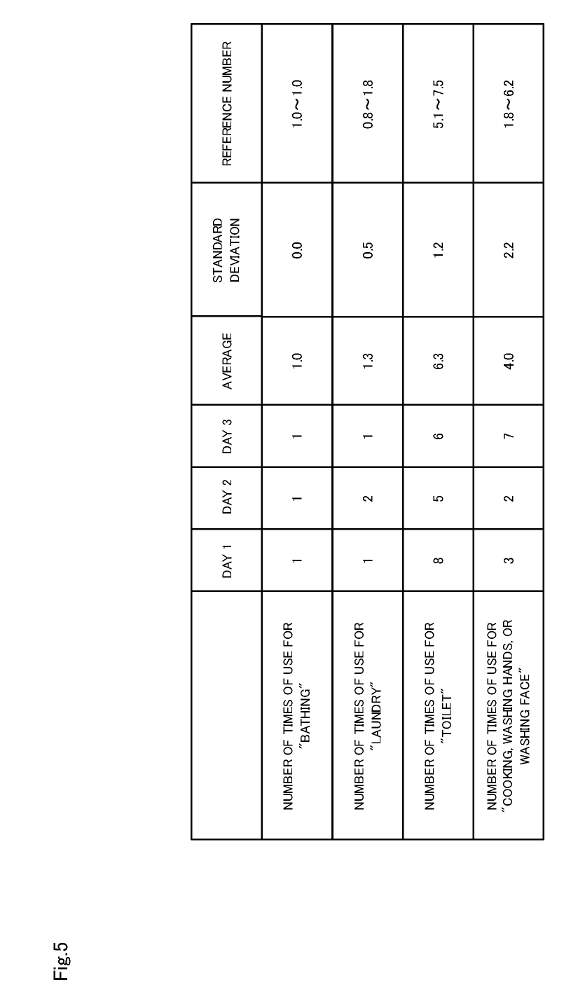

FIG. 5 shows examples of reference numbers set by the reference number setting unit 33. The examples of reference numbers shown in FIG. 5 are calculated using tap water use data of the last three days. Specifically, the reference number setting unit 33 calculates the average number of times tap water was used in the three days, as well as a standard deviation corresponding thereto, for each of the following purposes: bathing; laundry; using a toilet; and cooking, washing hands, or washing a face. Then, for each purpose, the reference number setting unit 33 obtains a reference number using the calculated average and standard deviation.

Note that the reference number setting unit 33 may update the reference numbers by performing calculation always using the latest data, or may set values that have been calculated using data of a specific term as the reference numbers. When the reference numbers are updated always using the latest data, the latest condition of the watched person can always be used as a criterion. That is to say, even if the condition of the watched person is changing over a long period of time, an abnormality occurring in a short period of time can be detected without getting affected by the change. Furthermore, as this updating method is not affected by individual differences among watched people, the reference numbers need not be set on a person-to-person basis. On the other hand, when the reference numbers are set using data of a specific term, a criterion can always be kept constant even if an abnormality is occurring gradually.

For each purpose of using tap water stored in the tap water use data storage unit 32, the abnormality determination unit 34 determines whether an abnormality has occurred by comparing the number of times tap water was used for that purpose within a given term (e.g., one day) with the reference number set by the reference number setting unit 33.

Specifically, the abnormality determination unit 34 determines that the watched person is exhibiting an abnormality when the number of times tap water was used for the purpose of using a toilet or bathing, which is included among the purposes of using tap water, in one day is zero. There is a possibility that the watched person has collapsed if the watched person has not used a toilet for a day. Similarly, there is a possibility that the watched person has collapsed or is sick if the watched person has not bathed for a day.

Furthermore, for each purpose of using tap water, the abnormality determination unit 34 determines that the watched person is exhibiting an abnormality when the number of times tap water was used for that purpose within the given term is different from the reference number (when the number of times tap water was used for that purpose is outside a range set as the reference number). For example, there is a possibility that the watched person has frequent urination if the watched person has used a toilet many times.

In addition to the foregoing determinations based on the number of times tap water was used, the abnormality determination unit 34 determines that the watched person is exhibiting an abnormality when continuous use of tap water for 30 minutes or longer has occurred at least once. There is a possibility that the watched person has collapsed while using tap water if continuous use of tap water for 30 minutes or longer has occurred.

If the abnormality determination unit 34 determines that an abnormality has occurred, it outputs an abnormality detection signal to the abnormality notification unit 35.

When the abnormality determination unit 34 has output the abnormality detection signal, the abnormality notification unit 35 generates an abnormality notification signal, and outputs the abnormality notification signal to the display terminal 5 of the watching person via the communication unit 31. This abnormality notification signal contains the substance and the time of an abnormality exhibited by the watched person, and an address (e.g., an ID or an e-mail address) of the watching person. The abnormality notification unit 35 may notify the display terminal 5 of the watching person of the abnormality notification signal using any method, such as via e-mail or a dedicated web page.

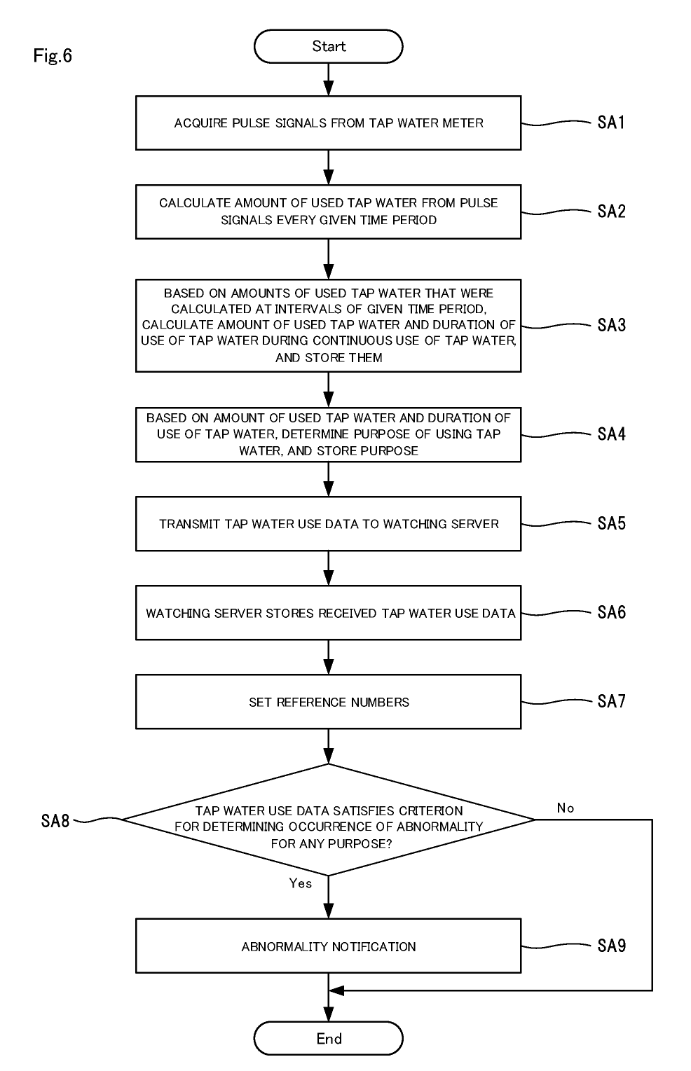

Using FIG. 6, a description is now given of the operations of the watching system 10 according to the first embodiment of the present invention. FIG. 6 is a flowchart showing the operations of the watching system 10. In the following description, FIGS. 1 and 3 will be referred to as appropriate. In the present embodiment, the watching method is implemented by causing the watching system 10 to operate. Therefore, the following description of the operations of the watching system 10 applies to the watching method according to the present embodiment.

As the tap water use detection system 1 is included in the watching system 10, the following description of the operations of the watching system 10 encompasses the operations of the tap water use detection system 1. In the present embodiment, as the tap water use detection method is implemented by causing the tap water use detection system 1 to operate, the following description of the operations of the watching system 10 applies to the tap water use detection method as well.

In the watching system 10, the tap water use detection system 1 operates first. In the tap water use detection system 1, the pulse signal acquisition unit 21 of the used tap water amount acquisition unit 11 acquires pulse signals that are output from the tap water meter 2 in accordance with an amount of used tap water (step SA1). Every given time period, the conversion unit 23 of the used tap water amount acquisition unit 11 calculates an amount of used tap water based on the acquired pulse signals and the result of counting by the count unit 22 (step SA2).

Based on the amounts of used tap water that were calculated by the used tap water amount acquisition unit 11 at intervals of the given time period, the tap water use calculation unit 12 calculates an amount of used tap water and the duration of use of tap water during continuous use of tap water (step SA3). The calculated amount of used tap water and duration of use of tap water are stored to the used tap water amount storage unit 14 (step SA3).

Subsequently, the tap water purpose determination unit 13 determines a purpose of using tap water based on the amount of used tap water and the duration of use of tap water calculated by the tap water use calculation unit 12 (step SA4). At this time, the tap water purpose determination unit 13 determines the purpose of using tap water based on the amount of used tap water and the duration of use of tap water with reference to the table shown in FIG. 2. The purpose of using tap water determined by the tap water purpose determination unit 13 is stored to the tap water purpose storage unit 15 (step SA4).

In the foregoing manner, the tap water use detection system 1 can determine the purpose of continuous use of tap water based on pulse signals output from the existing tap water meter 2. Therefore, the purpose of using tap water can be detected with high precision using a simple and low-cost method.

The purpose of using tap water detected by the tap water use detection system 1 is transmitted as tap water use data to the watching server 3 (step SA5). The tap water use data transmitted to the watching server 3 is received by the communication unit 31, and stored to the tap water use data storage unit 32 (step SA6).

Based on the tap water use data stored in the tap water use data storage unit 32, the reference number setting unit 33 obtains reference numbers that are used in determining the occurrence of an abnormality (step SA7). Specifically, for each purpose of using tap water, the reference number setting unit 33 calculates the reference number by obtaining the average number of times tap water was used for that purpose in the latest predetermined term, as well as a standard deviation corresponding thereto.

Subsequently, using the reference numbers set by the reference number setting unit 33, the abnormality determination unit 34 determines whether the tap water use data stored in the tap water use data storage unit 32 satisfies a criterion for determining the occurrence of an abnormality (step SA8). The criterion for determining the occurrence of an abnormality is: whether the number of times tap water was used for the purpose of using a toilet or bathing, which is included among the purposes of using tap water, within a given term (e.g., one day) is zero; for each purpose of using tap water, whether the number of times tap water was used for that purpose within the given term is different from the reference number; or whether continuous use of tap water for 30 minutes or longer has occurred at least once.

If the abnormality determination unit 34 determines that the tap water use data satisfies the criterion for determining the occurrence of an abnormality (YES of step SA8), the abnormality determination unit 34 outputs an abnormality determination signal to the abnormality notification unit 35, and the abnormality notification unit 35 notifies the display terminal 5 of the watching person of the abnormality via the communication unit 31 (step SA9).

On the other hand, if the abnormality determination unit 34 determines that the tap water use data does not satisfy the criterion for determining the occurrence of an abnormality (NO of step SA8), the present flow is ended without performing the abnormality notification (End).

Note that step SA1 of acquiring pulse signals from the tap water meter 2 corresponds to a used tap water amount acquisition step, and step SA3 of calculating an amount of used tap water and the duration of use of tap water based on the pulse signals acquired from the tap water meter 2 corresponds to a tap water use calculation step. Step SA4 of determining a purpose of using tap water based on the calculated amount of used tap water and duration of use of tap water corresponds to a tap water purpose determination step, and step SA9 of notifying the watching person of an abnormality if the tap water use data satisfies the criterion for determining the occurrence of an abnormality for any purpose of using tap water corresponds to an abnormality notification step. Step SA7 of setting the reference numbers corresponds to a reference number setting step.

According to the configurations of the present embodiment, an amount of used tap water and the duration of use of tap water can be calculated based on pulse signals output from the existing tap water meter 2, and a purpose of using tap water can be determined from the values of the calculated amount and duration. Therefore, a purpose of using tap water can be detected with high precision using simple and low-cost configurations.

For each obtained purpose of using tap water, the occurrence of an abnormality can be determined based on the number of times tap water was used and the duration of use of tap water. That is to say, with the configurations of the present embodiment, a simple and low-cost watching system can be constructed.

Furthermore, for each purpose of using tap water, the reference number that is used in determining the occurrence of an abnormality is calculated by obtaining the average number of times tap water was used for that purpose in the latest predetermined term, as well as a standard deviation corresponding thereto. This makes it possible to determine the occurrence of an abnormality always based on the latest condition of the watched person. Therefore, the precision of determining an abnormality exhibited by the watched person can be improved.

Moreover, with the foregoing configurations, a living pattern of the watched person can be learnt in determining the occurrence of an abnormality. Thus, the occurrence of an abnormality can be determined without getting affected by individual differences among watched people, and without getting affected by long-term changes in the conditions of watched people.

It is sufficient for the program according to the first embodiment of the present invention to cause computers to execute steps SA1 to SA9 shown in FIG. 6. The tap water use detection system, the watching system, the tap water use detection method, and the watching method according to the present embodiment can be realized by installing this program in the computers and executing the installed program. In this case, a central processing unit (CPU) of one computer functions as the used tap water amount acquisition unit 11, the tap water use calculation unit 12, and the tap water purpose determination unit 13 of the tap water use detection system 1, and executes processing. A CPU of another computer functions as the reference number setting unit 33, the abnormality determination unit 34, and the abnormality notification unit 35 of the watching server 3, and executes processing.

In the present embodiment, the used tap water amount storage unit 14 and the tap water purpose storage unit 15 are realized by storing a data file that composes these units to a storage device provided in one computer, or by loading a recording medium having stored therein this data file to a reading device that is connected to one computer.

Similarly, in the present embodiment, the tap water use data storage unit 32 is realized by storing a data file that composes this unit to a storage device provided in another computer, or by loading a recording medium having stored therein this data file to a reading device that is connected to another computer.

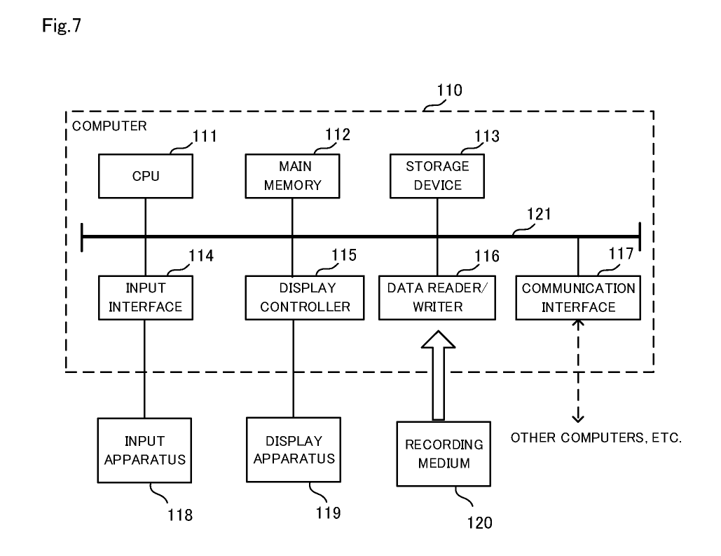

Using FIG. 7, a description is now given of the computers that respectively realize the tap water use detection system 1 and the watching server 10 by executing the program according to the present embodiment. FIG. 7 is a block diagram showing an example of the computer that realizes the watching system 10 according to the embodiment of the present invention. As the computer that realizes the tap water use detection system 1 and the computer that realizes the watching server 10 are configured in a similar manner, the following describes the computer that realizes the tap water use detection system 1.

As shown in FIG. 7, a computer 110 includes a CPU 111, a main memory 112, a storage device 113, an input interface 114, a display controller 115, a data reader/writer 116, and a communication interface 117. These components are connected in such a manner that they can perform data communication with one another via a bus 121.

The CPU 111 performs various types of calculation by deploying the program (code) according to the present embodiment stored in the storage device 113 to the main memory 112, and executing the deployed program in a predetermined order. The main memory 112 is typically a volatile storage device, such as a dynamic random-access memory (DRAM). The program according to the present embodiment is provided while being stored in a computer-readable recording medium 120. The program according to the present embodiment may be distributed over the Internet connected via the communication interface 117.

Specific examples of the storage device 113 include a hard disk drive and a semiconductor storage device, such as a flash memory. The input interface 114 mediates data transmission between the CPU 111 and an input apparatus 118, such as a keyboard and a mouse. The display controller 115 is connected to a display apparatus 119, and controls display on the display apparatus 119.

The data reader/writer 116 mediates data transmission between the CPU 111 and the recording medium 120. The data reader/writer 116 reads out the program from the recording medium 120, and writes the result of processing of the computer 110 to the recording medium 120. The communication interface 117 mediates data transmission between the CPU 111 and other computers.

Specific examples of the recording medium 120 include: a general-purpose semiconductor storage device, such as CompactFlash® (CF) and Secure Digital (SD); a magnetic storage medium, such as a flexible disk; and an optical storage medium, such as a compact disc read-only memory (CD-ROM).

### Second Embodiment

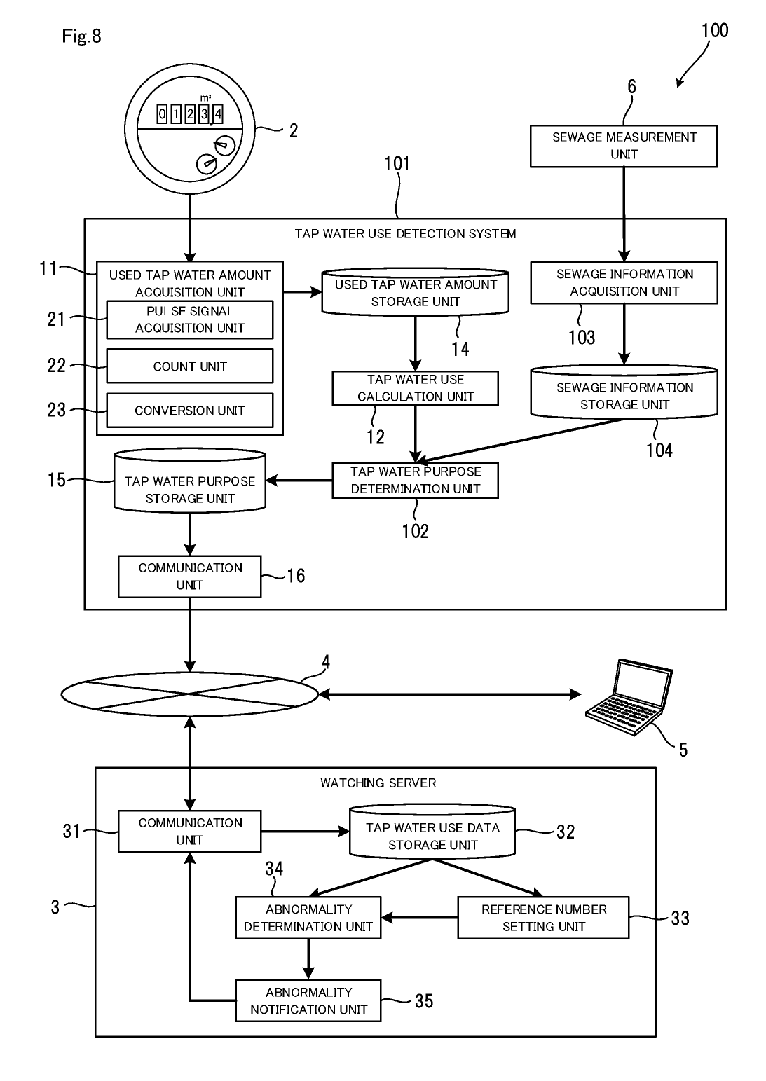

FIG. 8 shows a configuration of a watching system 100 including a tap water use detection system 101 according to a second embodiment of the present invention. The watching system 100 according to the present embodiment differs from the watching system 1 according to the first embodiment only in the configurations of the tap water use detection system 101. Therefore, the following mainly describes the configurations of the tap water use detection system 101. Constituents that are similar to those of the first embodiment will be given the same reference signs thereas, and a description thereof will be omitted.

The tap water use detection system 101 according to the present embodiment determines a purpose of using tap water in consideration of whether sewage has flowed in addition to an amount of used tap water and the duration of use of tap water. Specifically, the tap water use detection system 101 includes a used tap water amount acquisition unit 11, a used tap water amount storage unit 14, a tap water use calculation unit 12, a tap water purpose determination unit 102, a tap water purpose storage unit 15, a communication unit 16, a sewage information acquisition unit 103, and a sewage information storage unit 104.

The sewage information acquisition unit 103 acquires a signal (information related to use of sewage drains) output from a sewage measurement unit 6 for detecting whether sewage has flowed. The sewage measurement unit 6 is attached to, for example, a sewage septic tank in which sewage is collected, and is composed of a sound sensor that detects the sound of sewage flowing into the sewage septic tank. By thus attaching the sewage measurement unit 6 to the sewage septic tank, overall use of sewage drains can easily be detected. The sewage information acquisition unit 103 is configured to detect use of sewage drains, generate a sewage drain use signal, and output the sewage drain use signal when the sewage measurement unit 6 has detected a sound volume of a given level or higher. This sewage drain use signal contains information indicating that sewage drains have been used, and information related to the time at which the sewage measurement unit 6 detected the sound of sewage.

The sewage information storage unit 104 is constituted by, for example, a storage device, such as a flash memory. The sewage information storage unit 104 stores sewage drain use signals output from the sewage information acquisition unit 103.

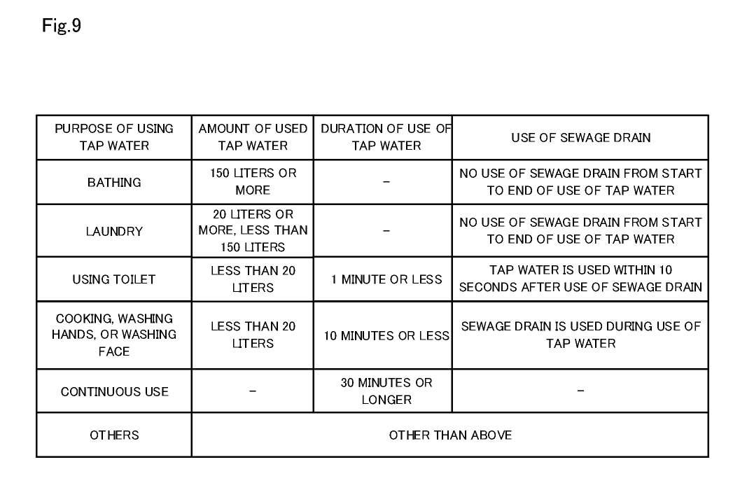

The tap water purpose determination unit 102 determines a purpose of using tap water based on an amount of used tap water and the duration of use of tap water that have been output from the tap water use calculation unit 12, which is configured similarly to that according to the first embodiment, and on the sewage drain use signals stored in the sewage information storage unit 104. Specifically, the tap water purpose determination unit 102 determines a purpose of using tap water from the amount of used tap water, the duration of use of tap water, whether sewage drains have been used, and the timing of use of sewage drains based on the criteria shown in FIG. 9.

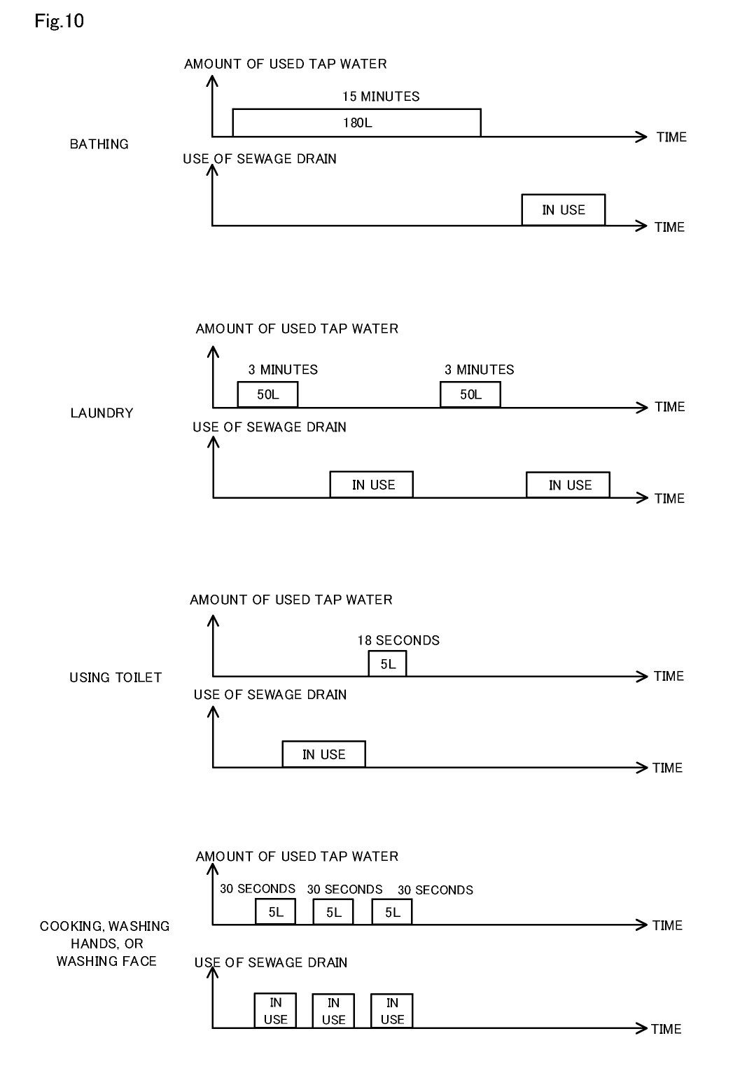

Note that the criteria shown in FIG. 9 have been decided on based on the relationships shown in FIG. 10, specifically, the relationships among an amount of used tap water, the duration of use of tap water, and use of sewage drains during general uses of tap water. That is to say, as shown in FIG. 10, when the purpose of using tap water is bathing, a sewage drain is used after a large amount of tap water is used. When the purpose of using tap water is laundry, a sewage drain is used after tap water is used in wash and rinse cycles. When the purpose of using tap water is using a toilet, a small amount of tap water is used after a sewage drain is used. When the purpose of using tap water is cooking, washing hands, or washing a face, a small amount of tap water is used frequently, almost simultaneously with use of a sewage drain.

As described above, in the present embodiment, the tap water purpose determination unit 102 determines a purpose of using tap water in consideration of whether sewage drains have been used and the timing of use of sewage drains, in addition to an amount of used tap water and the duration of use of tap water. Accordingly, the purpose of using tap water can be determined with higher precision than when the purpose of using tap water is determined in consideration of an amount of used tap water and the duration of use of tap water as in the first embodiment. Therefore, by using the result of this determination in the watching system, an abnormality exhibited by a watched person can be detected with higher precision.

As the watching server 3 is configured similarly to that according to the first embodiment, a description thereof will be omitted.

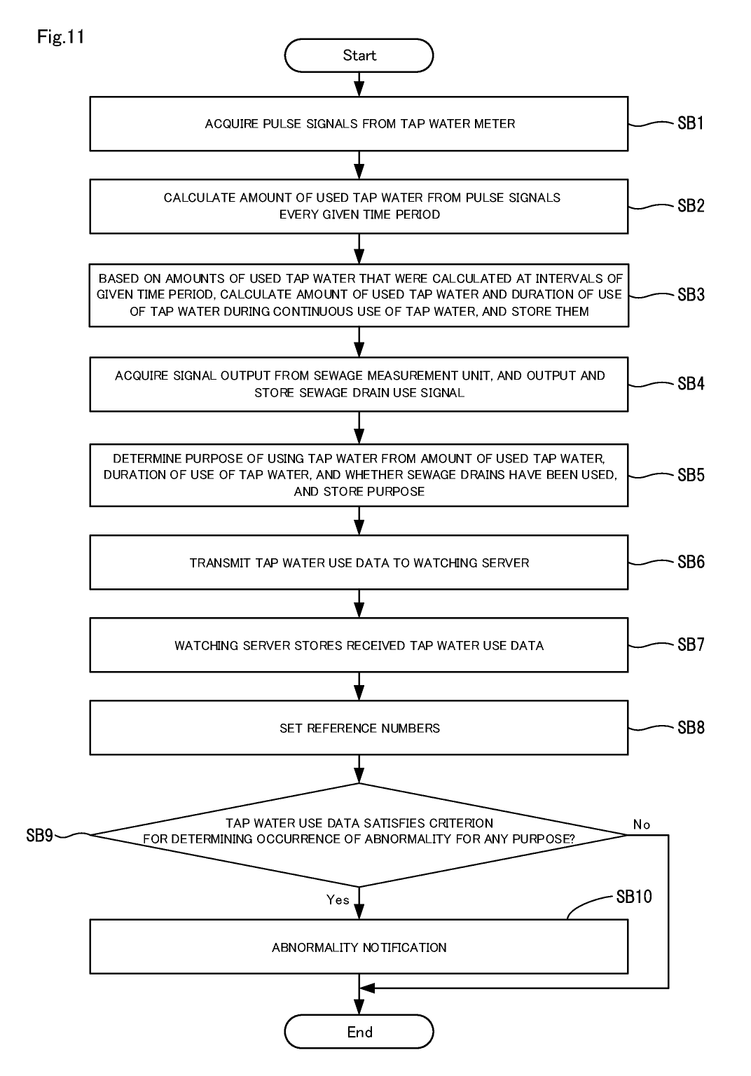

Using FIG. 11, a description is now given of the operations of the watching system 100 according to the embodiment of the present invention. FIG. 11 is a flowchart showing the operations of the watching system 100. In the following description, FIGS. 1, 3, and 8 will be referred to as appropriate. In the present embodiment also, the watching method is implemented by causing the watching system 100 to operate. Therefore, the following description of the operations of the watching system 100 applies to the watching method according to the present embodiment.

Note that the flow shown in FIG. 11 differs from the flow shown in FIG. 6 according to the first embodiment in additionally including step SB4, and in the determination of a purpose of using tap water in step SB5. In other words, steps SB1 to SB3 and SB6 to SB10 are similar to steps SA1 to SA3 and SA5 to SA9 of FIG. 6 according to the first embodiment, and thus a description thereof will be omitted. Below, only the differences from the flow shown in FIG. 6 according to the first embodiment will be discussed.

Referring to the flow shown in FIG. 11, in step SB4, the sewage information acquisition unit 103 acquires a signal output from the sewage measurement unit 6, and generates and outputs a sewage drain use signal. The sewage drain use signal is stored to the sewage information storage unit 104.

In the next step SB5, the tap water purpose determination unit 102 determines a purpose of using tap water based on the amount of used tap water and the duration of use of tap water calculated in step SB3, and on the sewage drain use signal acquired in step SB4. Specifically, the tap water purpose determination unit 102 determines the purpose of using tap water from the amount of used tap water, the duration of use of tap water, and use of sewage drains based on the criteria shown in FIG. 9.

Accordingly, the purpose of using tap water can be determined with higher precision than when the purpose of using tap water is determined in consideration of an amount of used tap water and the duration of use of tap water as in the first embodiment.

Note that step SB4 of acquiring a signal output from the sewage measurement unit corresponds to a sewage information acquisition step.

A part or an entirety of the foregoing embodiments can be described as, but is not limited to, the following Supplementary Notes 1 to 15.

### (Supplementary Note 1)

A tap water use detection system that detects a purpose of using tap water based on a use status of tap water, the tap water use detection system including:
a used tap water amount acquisition unit that acquires information related to an amount of used tap water from a used tap water amount measurement unit for measuring an amount of used tap water;
a tap water use calculation unit that calculates an amount of used tap water and duration of use of tap water based on the information related to the amount of used tap water acquired by the used tap water amount acquisition unit; and
a tap water purpose determination unit that determines a purpose of using tap water based on the amount of used tap water and the duration of use of tap water calculated by the tap water use calculation unit.

### (Supplementary Note 2)

The tap water use detection system according to Supplementary Note 1, further including
a sewage information acquisition unit that acquires information related to use of sewage drains, the information being output from a sewage measurement unit for measuring whether sewage drains have been used, wherein
the tap water purpose determination unit determines the purpose of using tap water in consideration of the information related to use of sewage drains acquired by the sewage information acquisition unit in addition to the amount of used tap water and the duration of use of tap water.

### (Supplementary Note 3)

The tap water use detection system according to Supplementary Note 1, wherein
the used tap water amount measurement unit is a tap water meter, and
the used tap water amount acquisition unit acquires a signal output from the tap water meter as the information related to the amount of used tap water.

### (Supplementary Note 4)

A watching system that detects an abnormality exhibited by a watched person, the watching system including:
the tap water use detection system according to Supplementary Note 1; and
an abnormality notification unit that notifies a watching person of an abnormality when the number of times tap water has been used within a given term for the purpose of using tap water determined by the tap water purpose determination unit is different from a reference number.

### (Supplementary Note 5)

The watching system according to Supplementary Note 4, further including
a reference number setting unit that sets the reference number, wherein
the reference number setting unit detects the number of times tap water has been used within a predetermined term for the purpose of using tap water determined by the tap water purpose determination unit, and sets the reference number in consideration of the average number of times tap water has been used and a standard deviation that have been obtained based on a result of the detection.

### (Supplementary Note 6)

A tap water use detection method of detecting a purpose of using tap water based on a use status of tap water, the tap water use detection method including:
a used tap water amount acquisition step of acquiring information related to an amount of used tap water from a used tap water amount measurement unit for measuring an amount of used tap water;
a tap water use calculation step of calculating an amount of used tap water and duration of use of tap water based on the information related to the amount of used tap water acquired in the used tap water amount acquisition step; and
a tap water purpose determination step of determining a purpose of using tap water based on the amount of used tap water and the duration of use of tap water calculated in the tap water use calculation step.

### (Supplementary Note 7)

The tap water use detection method according to Supplementary Note 6, further including
a sewage information acquisition step of acquiring information related to use of sewage drains, the information being output from a sewage measurement unit for measuring whether sewage drains have been used, wherein
the tap water purpose determination step determines the purpose of using tap water in consideration of the information related to use of sewage drains acquired in the sewage information acquisition step in addition to the amount of used tap water and the duration of use of tap water.

### (Supplementary Note 8)

The tap water use detection method according to Supplementary Note 6, wherein
the used tap water amount measurement unit is a tap water meter, and
the used tap water amount acquisition step acquires a signal output from the tap water meter as the information related to the amount of used tap water.

### (Supplementary Note 9)

A watching method of detecting an abnormality exhibited by a watched person, the watching method including:
a used tap water amount acquisition step of acquiring information related to an amount of used tap water from a used tap water amount measurement unit for measuring an amount of used tap water;
a tap water use calculation step of calculating an amount of used tap water and duration of use of tap water based on the information related to the amount of used tap water acquired in the used tap water amount acquisition step;
a tap water purpose determination step of determining a purpose of using tap water based on the amount of used tap water and the duration of use of tap water calculated in the tap water use calculation step; and
an abnormality notification step of notifying a watching person of an abnormality when the number of times tap water has been used within a given term for the purpose of using tap water determined in the tap water purpose determination step is different from a reference number.

### (Supplementary Note 10)

The watching method according to Supplementary Note 9, further including
a reference number setting step of setting the reference number, wherein
the reference number setting step detects the number of times tap water has been used within a predetermined term for the purpose of using tap water determined in the tap water purpose determination step, and sets the reference number in consideration of the average number of times tap water has been used and a standard deviation that have been obtained based on a result of the detection.

### (Supplementary Note 11)

A computer-readable recording medium having recorded therein a program including an instruction for causing a computer to execute:
a used tap water amount acquisition step of acquiring information related to an amount of used tap water from a used tap water amount measurement unit for measuring an amount of used tap water;
a tap water use calculation step of calculating an amount of used tap water and duration of use of tap water based on the information related to the amount of used tap water acquired in the used tap water amount acquisition step; and
a tap water purpose determination step of determining a purpose of using tap water based on the amount of used tap water and the duration of use of tap water calculated in the tap water use calculation step.

### (Supplementary Note 12)

The computer-readable recording medium according to Supplementary Note 11, wherein
the instruction included in the program causes the computer to further execute a sewage information acquisition step of acquiring information related to use of sewage drains, the information being output from a sewage measurement unit for measuring whether sewage drains have been used, and
the tap water purpose determination step determines the purpose of using tap water in consideration of the information related to use of sewage drains acquired in the sewage information acquisition step in addition to the amount of used tap water and the duration of use of tap water.

### (Supplementary Note 13)

The computer-readable recording medium according to Supplementary Note 11,wherein
the used tap water amount measurement unit is a tap water meter, and
the used tap water amount acquisition step acquires a signal output from the tap water meter as the information related to the amount of used tap water.

### (Supplementary Note 14)

The computer-readable recording medium according to Supplementary Note 11, wherein
the instruction included in the program causes the computer to further execute an abnormality notification step of notifying a watching person of an abnormality when the number of times tap water has been used within a given term for the purpose of using tap water determined in the tap water purpose determination step is different from a reference number.

### (Supplementary Note 15)

The computer-readable recording medium according to Supplementary Note 14, wherein
the instruction included in the program causes the computer to further execute a reference number setting step of setting the reference number, and
the reference number setting step detects the number of times tap water has been used within a predetermined term for the purpose of using tap water determined in the tap water purpose determination step, and sets the reference number in consideration of the average number of times tap water has been used and a standard deviation that have been obtained based on a result of the detection.

Although the invention of the present application has been described thus far with reference to the embodiments, the invention of the present application is not limited to the foregoing embodiments. Various changes that can be understood by a person skilled in the art can be made to the configurations and details of the invention of the present application within the scope of the invention of the present application.

The present application claims the benefit of priority from Japanese Patent Application No. 2015-071275, filed Mar. 31, 2015, the disclosure of which is incorporated herein by reference in its entirety.

### INDUSTRIAL APPLICABILITY

The present invention can be used in a tap water use detection system for detecting a purpose of using tap water in accordance with a use status of tap water.

### REFERENCE SIGNS LIST

1, 101 tap water use detection system
2 tap water meter (used tap water amount measurement unit)
3 watching server
4 network
5 display terminal
6 sewage flow rate measurement unit
10, 100 watching system
11 used tap water amount acquisition unit
12 tap water use calculation unit
13, 102 tap water purpose determination unit
14 used tap water amount storage unit
15 tap water purpose storage unit
16 communication unit
21 pulse signal acquisition unit
22 count unit
23 conversion unit
31 communication unit
32 tap water use data storage unit
33 reference number setting unit
34 abnormality determination unit
35 abnormality notification unit
103 sewage information acquisition unit
104 sewage information storage unit
110 computer
111 CPU
112 main memory
113 storage device
114 input interface
115 display controller
116 data reader/writer
117 communication interface
118 input apparatus
119 display apparatus
120 recording medium
121 bus

1. A tap water use detection system that detects a purpose of using tap water based on a use status of tap water, the tap water use detection system comprising:
a used tap water amount acquisition unit that acquires information related to an amount of used tap water from a used tap water amount measurement unit for measuring an amount of used tap water;
a tap water use calculation unit that calculates an amount of used tap water and duration of use of tap water based on the information related to the amount of used tap water acquired by the used tap water amount acquisition unit; and
a tap water purpose determination unit that determines a purpose of using tap water based on the amount of used tap water and the duration of use of tap water calculated by the tap water use calculation unit.

2. The tap water use detection system according to claim 1, further comprising
a sewage information acquisition unit that acquires information related to use of sewage drains, the information being output from a sewage measurement unit for measuring whether sewage drains have been used, wherein
the tap water purpose determination unit determines the purpose of using tap water in consideration of the information related to use of sewage drains acquired by the sewage information acquisition unit in addition to the amount of used tap water and the duration of use of tap water.

3. The tap water use detection system according to claim 1, wherein
the used tap water amount measurement unit is a tap water meter, and
the used tap water amount acquisition unit acquires a signal output from the tap water meter as the information related to the amount of used tap water.

4. A watching system that detects an abnormality exhibited by a watched person, the watching system comprising:
the tap water use detection system according to claim 1; and
an abnormality notification unit that notifies a watching person of an abnormality when the number of times tap water has been used within a given term for the purpose of using tap water determined by the tap water purpose determination unit is different from a reference number.

5. The watching system according to claim 4, further comprising
a reference number setting unit that sets the reference number, wherein
the reference number setting unit detects the number of times tap water has been used within a predetermined term for the purpose of using tap water determined by the tap water purpose determination unit, and sets the reference number in consideration of the average number of times tap water has been used and a standard deviation that have been obtained based on a result of the detection.

6. A tap water use detection method of detecting a purpose of using tap water based on a use status of tap water, the tap water use detection method comprising:
a used tap water amount acquisition step of acquiring information related to an amount of used tap water from a used tap water amount measurement unit for measuring an amount of used tap water;
a tap water use calculation step of calculating an amount of used tap water and duration of use of tap water based on the information related to the amount of used tap water acquired in the used tap water amount acquisition step; and
a tap water purpose determination step of determining a purpose of using tap water based on the amount of used tap water and the duration of use of tap water calculated in the tap water use calculation step.

7. The tap water use detection method according to claim 6, further comprising
a sewage information acquisition step of acquiring information related to use of sewage drains, the information being output from a sewage measurement unit for measuring whether sewage drains have been used, wherein
the tap water purpose determination step determines the purpose of using tap water in consideration of the information related to use of sewage drains acquired in the sewage information acquisition step in addition to the amount of used tap water and the duration of use of tap water.

8. The tap water use detection method according to claim 6, wherein
the used tap water amount measurement unit is a tap water meter, and
the used tap water amount acquisition step acquires a signal output from the tap water meter as the information related to the amount of used tap water.

9. A watching method of detecting an abnormality exhibited by a watched person, the watching method comprising:
the used tap water amount acquisition step, the tap water use calculation step, and the tap water purpose determination step of the tap water use detection method according to claim 6; and
an abnormality notification step of notifying a watching person of an abnormality when the number of times tap water has been used within a given term for the purpose of using tap water determined in the tap water purpose determination step is different from a reference number.

10. The watching method according to claim 9, further comprising
a reference number setting step of setting the reference number, wherein
the reference number setting step detects the number of times tap water has been used within a predetermined term for the purpose of using tap water determined in the tap water purpose determination step, and sets the reference number in consideration of the average number of times tap water has been used and a standard deviation that have been obtained based on a result of the detection.

11. A non-transitory computer-readable recording medium having recorded therein a program including an instruction for causing a computer to execute:
a used tap water amount acquisition step of acquiring information related to an amount of used tap water from a used tap water amount measurement unit for measuring an amount of used tap water;
a tap water use calculation step of calculating an amount of used tap water and duration of use of tap water based on the information related to the amount of used tap water acquired in the used tap water amount acquisition step; and
a tap water purpose determination step of determining a purpose of using tap water based on the amount of used tap water and the duration of use of tap water calculated in the tap water use calculation step.

12. The non-transitory computer-readable recording medium according to claim 11, wherein
the instruction included in the program causes the computer to further execute a sewage information acquisition step of acquiring information related to use of sewage drains, the information being output from a sewage measurement unit for measuring whether sewage drains have been used, and
the tap water purpose determination step determines the purpose of using tap water in consideration of the information related to use of sewage drains acquired in the sewage information acquisition step in addition to the amount of used tap water and the duration of use of tap water.

13. The non-transitory computer-readable recording medium according to claim 11, wherein
the used tap water amount measurement unit is a tap water meter, and
the used tap water amount acquisition step acquires a signal output from the tap water meter as the information related to the amount of used tap water.

14. The non-transitory computer-readable recording medium according to claim 11, wherein
the instruction included in the program causes the computer to further execute an abnormality notification step of notifying a watching person of an abnormality when the number of times tap water has been used within a given term for the purpose of using tap water determined in the tap water purpose determination step is different from a reference number.

15. The non-transitory computer-readable recording medium according to claim 14, wherein
the instruction included in the program causes the computer to further execute a reference number setting step of setting the reference number, and
the reference number setting step detects the number of times tap water has been used within a predetermined term for the purpose of using tap water determined in the tap water purpose determination step, and sets the reference number in consideration of the average number of times tap water has been used and a standard deviation that have been obtained based on a result of the detection.
